(19) United States
(12) Patent Application Publication
(10) Pub. No.: US 2023/0049706 A1
(43) Pub. Date: Feb. 16, 2023

(54) POWER ACTUATOR FOR AUTOMOTIVE PASSENGER DOOR

(71) Applicant: Hi-Lex Controls, Inc., Rochester Hills, MI (US)

(72) Inventors: John M. Heiberger, Grand Blanc, MI (US); Favad Shah, Rochester Hills, MI (US); Steve Brinck, Rochester Hills, MI (US)

(21) Appl. No.: 17/444,842

(22) Filed: Aug. 11, 2021

(51) Int. Cl. E05F 15/622

(52) U.S. Cl. CPC E05F 15/622; E05Y 2900/531; E05Y 2201/21; E05Y 2201/216; E05Y 2201/41; E05Y 2201/422

(57) ABSTRACT

A power actuator is configured for a hinged vehicle door with a generally vertical hinge axis. The power actuator includes a motor-gearbox assembly, a slip clutch, a friction brake, a threaded spindle with a motor-side bearing, and a spindle nut affixed to a spindle tube, configured to travel along the threaded spindle during a rotation of the spindle. The slip clutch and the friction brake are operatively positioned between the motor-gearbox assembly and the motor-side bearing. The power actuator does not need to include a biasing element acting on the spindle nut toward an extended position because such a biasing element is unnecessary where the hinge axis is generally parallel to the direction of gravity.

### TECHNICAL FIELD

The present disclosure relates to a power actuator for opening and closing a door of a motor vehicle. In particular, the door operated by the actuator may be a passenger door or any hinged door that opens sideways about a generally vertical axis, including a swing-out tailgate of pickup trucks and split rear swing doors on sports utility vehicles.

### BACKGROUND

Generally, in the terminology used in this disclosure, doors differ from hatches and tailgates in that the hinges are arranged in a vertical swing axis, i.e. parallel to the direction of gravity so that the swing door opens and closes in a horizontal swing plane that is perpendicular to the direction of gravity. The terms “vertical,” “horizontal,” and “parallel/perpendicular to the direction of gravity” are to be understood to include deviations of no more than 20 degrees from the vertical or horizontal direction, respectively, so that a door movement about the hinge axis is greatly unaffected by gravitational forces.

But even absent gravitational forces, the inertia and internal spring mechanisms of swing doors require physical force to open and close them.

Several approaches have been made to provide a power actuator for an automotive swing door to facilitate the opening and closing movement and to impede such a movement when it is not intended.

### SUMMARY

The present disclosure describes a power actuator for a hinged vehicle door with a generally vertical hinge axis. The power actuator comprises a motor-gearbox assembly, a slip clutch, a friction brake, a threaded spindle with a motor-side bearing, and a spindle nut affixed to a spindle tube, configured to travel along the threaded spindle during a rotation of the spindle. The slip clutch and the friction brake are operatively positioned between the motor-gearbox assembly and the motor-side bearing.

The power actuator does not need to include a biasing element acting on the spindle nut toward an extended position because such a biasing element is unnecessary where the hinge axis is generally parallel to the direction of gravity.

The slip clutch may be operatively disposed between the motor-gearbox assembly and the friction brake.

A circuit board arranged on a side of the a motor-gearbox assembly, remote from the threaded spindle, serves to operate the power actuator.

The power actuator may be contained in a housing having a motor tube and a spindle tube, wherein the motor tube is composed of two half shells surrounding the motor-gearbox assembly, the slip clutch, the friction brake, and the motor-side bearing.

The motor tube may located proximate to a door-side end of the power actuator and the spindle tube may be located proximate to a frame-side end of the power actuator so that the electric components are protected inside the vehicle door.

A door-side socket fixedly connected to the motor tube and a frame-side socket fixedly connected to the nut tube are configured to form a part of a door-side ball-and-socket joint or a part of a frame-side ball-and-socket joint, respectively.

According to another aspect of the present disclosure, a motor vehicle comprises a vehicle body with a door frame, a vehicle door opening and closing about a generally vertical hinge axis, and a power actuator as described above. The door frame includes a frame bracket located laterally inward from the vertical hinge axis with respect to the vehicle body. The frame bracket has a frame ball that forms a part of a frame-side ball-and-socket joint and cooperates with a frame-side socket fixedly connected to the nut tube of the power actuator.

The vehicle door includes a door bracket fastened to a structural bottom part of the vehicle door. The door bracket has a door ball that forms a part of a door-side ball-and-socket joint and cooperates with a door-side socket fixedly connected to the motor tube of the power actuator.

The power actuator extends in a generally horizontal direction.

The motor-gearbox assembly of the power actuator is disposed inside the vehicle door and the spindle tube extends out of the door to the frame-side ball-and-socket joint so that the motor-gearbox assembly is protected inside the door.

Further details become apparent from the following description of the appended drawings. The drawings are provided for purely illustrative purposes and are not intended to limit the scope of the present invention.

### BRIEF DESCRIPTION OF THE DRAWINGS

In the Drawings,

FIG. 1 shows a schematic illustration of the location of a power actuator in a passenger door of a vehicle;

FIG. 2 shows another illustration of the location of the power actuator in the vehicle with the passenger door itself omitted from the drawing;

FIG. 3 shows another illustration of the location of the power actuator with the passenger door in a closed state;

FIG. 4 shows another illustration of the location of the power actuator with the passenger door in an open state;

FIG. 5 shows a detail view of FIG. 4;

FIG. 6 shows the power actuator as an assembled unit in a perspective view;

FIG. 7 shows the power actuator as an assembled unit in a partially cut-open view; and

FIGS. 8, 9, 10 and 11 show various stages of assembly of the power actuator of FIGS. 6 and 7.

### DETAILED DESCRIPTION OF THE DRAWINGS

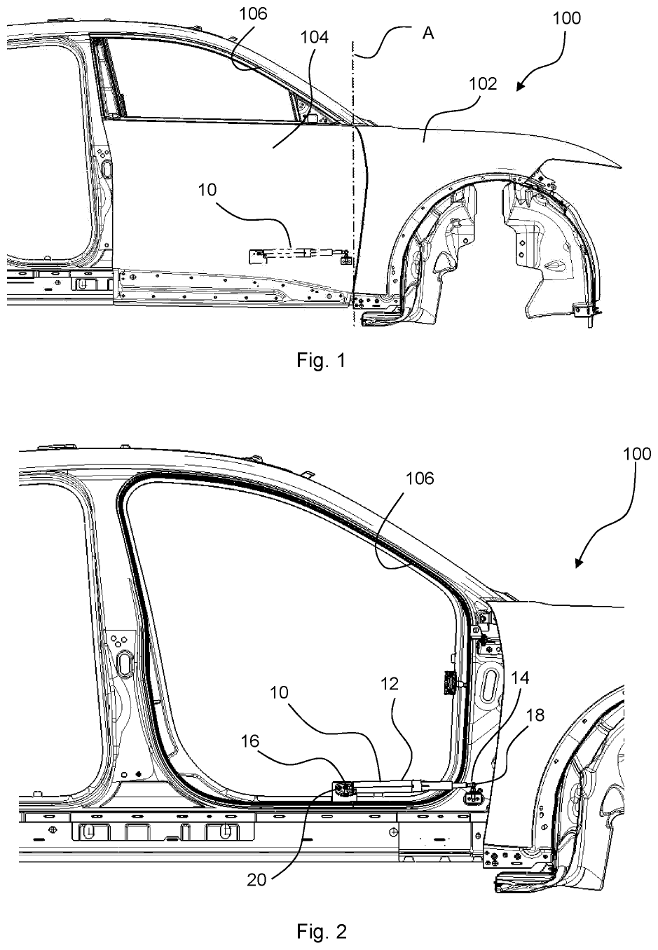

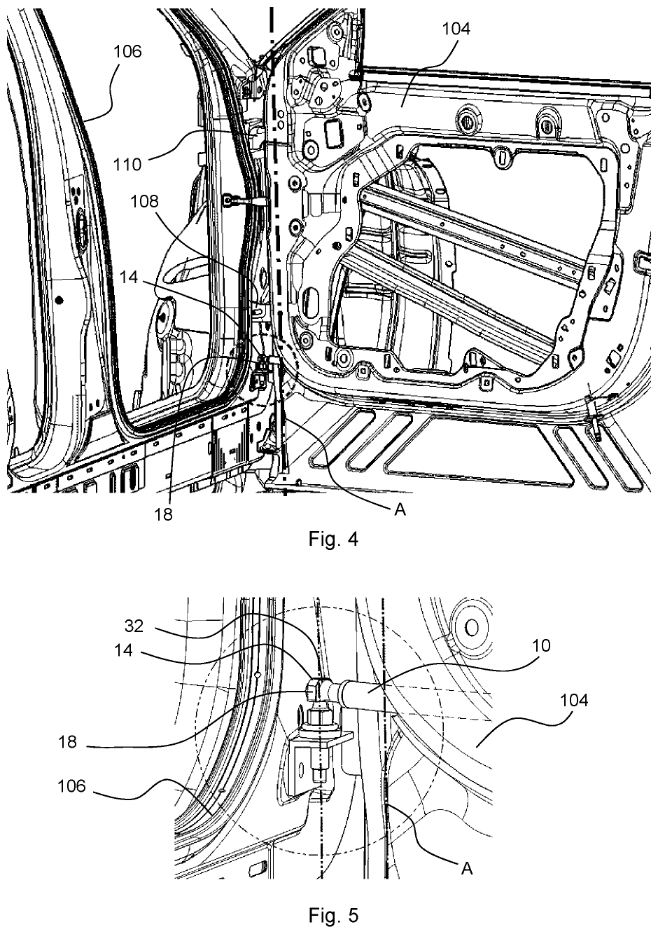

In FIG. 1, a motor vehicle 100 is represented by a portion of a vehicle body 102, which includes a vehicle door 104 in a door frame 106. The vehicle door 104 is a passenger door connected to the door frame 106 via hinges 108 and 110 (see FIG. 4) defining a hinge axis A generally extending in the vertical direction, i.e. generally parallel to the direction of gravity. As defined herein, the term “generally” indicates a permissible deviation from a strictly vertical direction of up to 20°.

An outline of a power actuator 10 is schematically superimposed on the vehicle door 104 to illustrate the position and orientation of the power actuator 10 relative to the vehicle door 104. FIG. 2 shows a similar view with the door removed to illustrate the position and orientation of the power actuator 10 relative to the door frame 106.

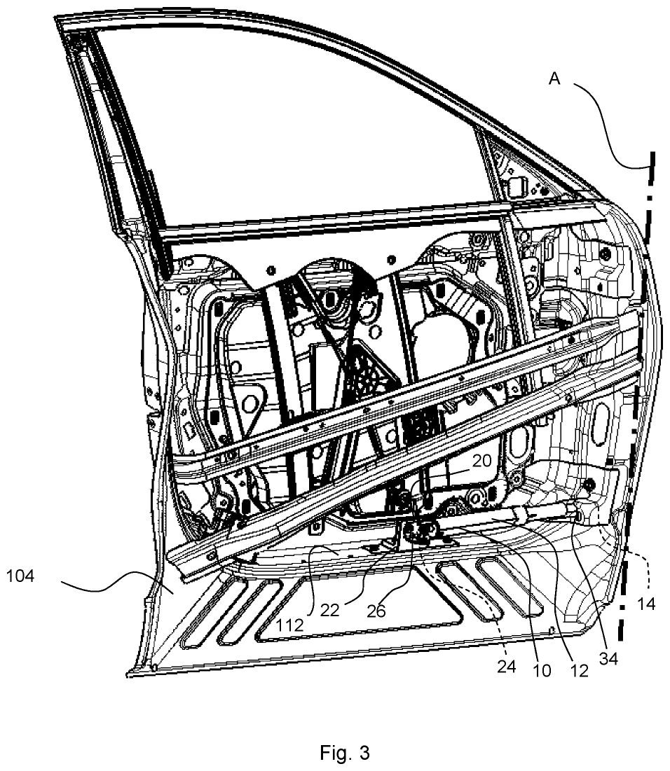

The power actuator 10 includes a telescopic strut 12 extending in a direction that is more closely aligned with a horizontal direction than a vertical direction. In other words, the telescopic strut 12 is parallel to or forms an acute angle with the horizontal direction. The power actuator 10 has a frame-side end 14 connected to the door frame 106 via a frame-side ball-and-socket joint 18 allowing an articulated movement of the telescopic strut 12 in all directions. A door-side end 16 is connected to a lower portion of the vehicle door 104 via a door-side ball-and-socket joint 20. The frame-side ball-and-socket joint 18 is located inward from the hinges 108 and 110 with respect to lateral direction of the motor vehicle 100 so that an expansion of the telescopic strut 12 exerts a torque on the vehicle door 104 about the hinge axis A (see FIGS. 3-5).

Referring to FIG. 3, a door bracket 22 is securely fastened to a structural bottom portion 112 of the vehicle door 104. The bottom portion 112 is a sheet metal component of the vehicle door 104. The door bracket 22 includes a door ball 24 forming part of the door-side ball-and-socket joint 20. Although it is possible to reverse the ball-and-socket joint arrangement to place the ball on the telescopic strut 12, the installation of the power actuator 10 is easier when the door bracket 22 features the door ball 24 and the telescopic strut 12 includes a door-side socket 26 at the door-side end 16. In the view of FIG. 3, the frame-side end 14 of the power actuator 10 is invisible as it extends through a passage 34 out of the vehicle door toward the door frame 106 on the side of the vehicle door 104 proximate to the hinge axis A.

As shown in FIGS. 4 and 5, the frame-side end 14 of the power actuator 10 extends out of the vehicle door 104 with a frame-side socket 32. Fastened to the door frame 106 is a frame bracket 28 with a frame ball 30 forming part of the frame-side ball-and-socket joint 18. The frame-side socket 32 of the power actuator 10, hitched on the frame ball 30 that forms the other part of the frame-side ball-and-socket joint 18.

Both the door ball 24 and the frame ball 30 are formed on a generally vertical pin so that the widest range of movement is enabled in a generally horizontal rotational plane, although deviations from this rotational plane are possible by the very nature of the ball-and-socket joints 18 and 20.

The hinge axis A, about which the vehicle door 104 opens and closes, is located laterally outward from the frame-side ball-and-socket joint 18 with respect to the vehicle 100 as shown in FIGS. 3-5. Accordingly, when the power actuator 10 is operated to extend its length, the power actuator 10 applies an opening torque to the vehicle door 104 via the frame-side ball-and-socket joint 18. Conversely, when the power actuator 10 is operated to contract, it exerts a closing torque on the vehicle door 104.

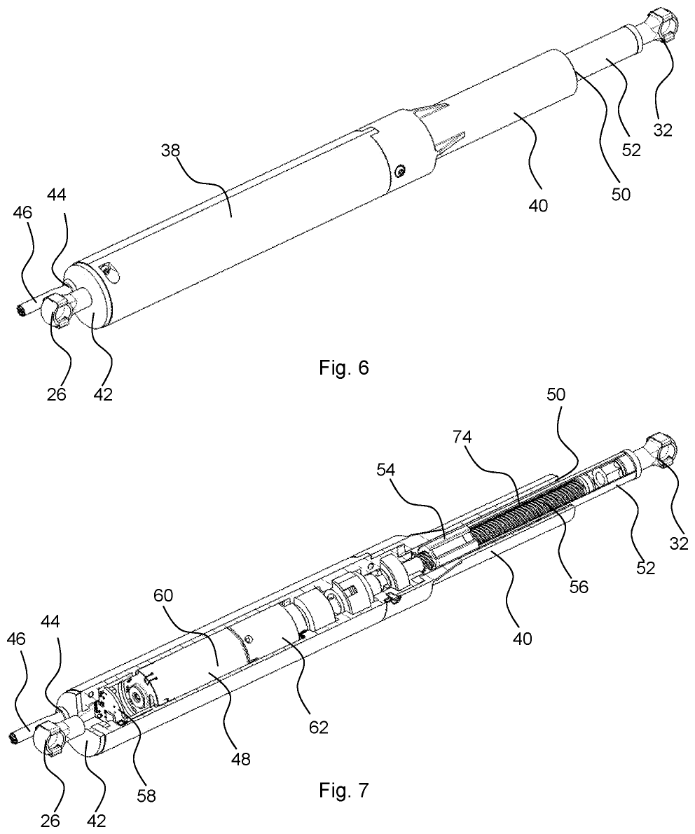

FIGS. 6 and 7 show the power actuator 10 in an assembled state. FIG. 6 shows the power actuator 10 in a perspective view, while FIG. 7 provides a partially cut-open view. The power actuator 10 has a housing 36 with a motor tube 38 and a spindle tube 40 fixedly attached thereto. The motor tube 38 is located adjacent to the door-side end 16 of the power actuator 10, and the spindle tube 40 is located adjacent to the frame-side end 14 of the power actuator.

The motor tube 39 is closed with a door-side end cap 42 fixedly attached to the motor tube 38. The door-side end cap 42 carries the door-side socket 26 and has a grommet-lined cable opening 44, through which a power cable 46 is guided into the motor tube for powering an electric motor 48. The cable opening 46 is shown as an axial through-hole, but depending on the architecture of the vehicle door 104, the cable opening 46 may alternatively be a radial opening.

The spindle tube 40 has an axially open end face 50 at the frame-side end of the spindle tube 40, through which a nut tube 52 extends toward the frame-side end 14 of the power actuator 10. At the frame-side end 14, the nut tube 52 carries the frame-side socket 32 of the frame-side ball-and-socket joint 18. The nut tube 52 is axially movable with respect to the housing 36 and is coupled to a spindle nut 54 that travels longitudinally along a rotatable threaded spindle 56. Because at least one of the spindle nut 54 and the nut tube 52 is non-rotatably guided inside the spindle tube 40, a rotation of the spindle 56 results in a translatory longitudinal movement of the spindle nut 54 and thus the nut tube 52.

As evident from FIG. 7, the power actuator 10 does not contain a biasing element, such as a compression spring or a gas spring, that would urge the spindle nut 54 or the nut tube 56 toward the frame-side end 14 of the power actuator, i.e. toward an extended position. Such a biasing element is unnecessary because the general orientation of the power actuator 10 is horizontal and the hinge axis A of the vehicle door 104 is generally vertical. Accordingly, the power actuator 10 does not need to work against major gravitational forces acting on the vehicle door 104.

The slip clutch mechanically disengages when a torque is applied to the spindle via the spindle nut 54, i.e. from the output end. At the same time, the friction brake engages the spindle nut and stops a further closing movement of the vehicle door 104. So while the thread of the spindle 56 and of the spindle nut 54 is a coarse thread that is not self-locking, the slip clutch 66 and the friction brake block a movement of the vehicle door 104 that is not driven by the moto-gearbox assembly 60.

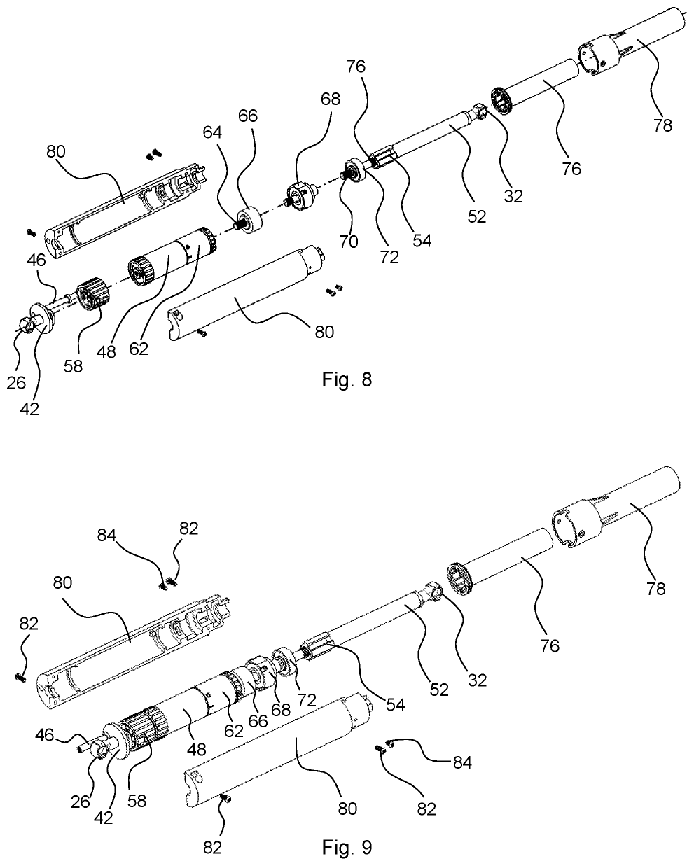

FIG. 8 shows individual parts of the power actuator 10 in a disassembled state in an exploded view. Starting at the adjacent to the door-side end cap 42 that includes the door-side socket and the cable passage, is a circuit board foo controlling the power actuator 10. Adjacent to the circuit board is a motor-gearbox assembly 60 with an electric motor 48 followed by a compact speed-reduction gearbox 62 containing two stages of planetary gears. A suitable gearbox 62 is, for example, disclosed in U.S. Pat. No. 9,822,843, which is incorporated herein by reference in its entirety.

The gearbox 62 receives a clutch input shaft 64 of a mechanical slip clutch 66 operative to engage the clutch input shaft 64 with or disengage the clutch input shaft 64 from a friction brake 68. The friction brake 68 acts between the spindle 56 and the surrounding spindle tube 40 and is capable to enable, slow down, or block a relative rotation between the spindle 56 and the spindle tube 40. The slip clutch 66 and the friction brake may be combined in one brake-clutch module as, for example, disclosed in U.S. Pat. No. 11,067,156, which is incorporated herein by reference in its entirety. Both the slip clutch 66 and the friction brake 68 are operatively positioned between the gearbox assembly 60 and the spindle 56. Preferably, the slip clutch 66 is operatively placed between the gearbox assembly 60 and the friction brake 68 so that the friction brake acts directly on an input shaft 70 of the spindle 56.

The spindle 56 includes a bearing 72 between the spindle input shaft 70 and the threaded portion 74 of the spindle. The threaded portion 74 is partly covered by the spindle nut 54 and the nut tube 52. The details inside the nut tube 52 are, however, visible in FIG. 7. The spindle nut 54 and the frame-side socket 32 are rigidly connected to opposite ends of the nut tube 52.

In the shown example, the spindle tube 40 is composed of a two-part structure with an inner guide sleeve 76 with an interior anti-rotation feature cooperating with the outer contour of the spindle nut 54, and an outer housing sleeve 78 surrounding the guide sleeve 76 and non-rotatably engaging the guide sleeve 76. The housing sleeve engages the motor tube to hold the power actuator 10 in an assembled state. As the power actuator 10 does not include a spring that would otherwise be disposed between the housing sleeve 78 and the guide sleeve 76, the spindle tube 40 may alternatively be formed as one monolithic part combining the guide sleeve 76 and the housing sleeve 78 by including the interior anti-rotation feature of the guide sleeve and having an attachment structure to connect the spindle tube 40 to the motor tube 38.

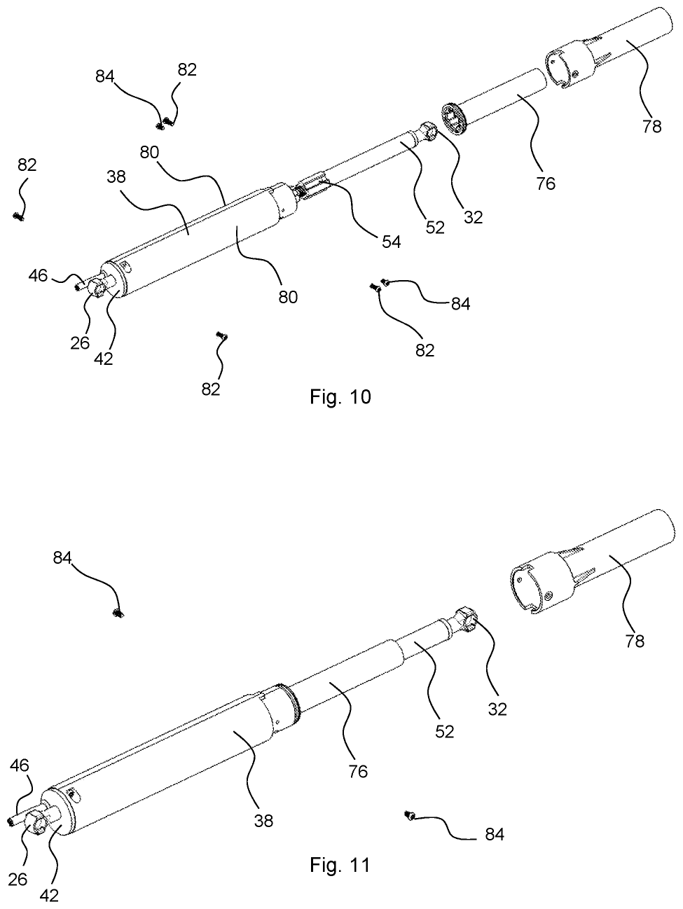

FIGS. 9 through 11 show assembly steps of the power actuator 10. In FIG. 9, the door-side end cap 42, the circuit board 58, the motor-gearbox assembly 60, the slip clutch 66, the brake module, and the spindle 56 carrying the spindle nut 54 and the nut tube 52 are assembled in a linear arrangement. In FIG. 10, two half shells 80 forming the motor tube 38 are closed around the subassembly so that the assembled parts up to and including the bearing 72 are enclosed by the motor tube 38. The two half shells 80 are affixed to the subassembly via screws 82 extending into the outer circumference of the circuit board 58 and of the friction brake 68, thereby preventing a separation of the individual parts in the subassembly. Subsequently, as shown in FIG. 11 the spindle tube 40, which can include one single tube or two as shown, is slipped over an end portion of the motor tube 38 and attached thereto via further screws 84 to complete the assembled power actuator 10 as shown in FIG. 6.

While the above description pertains to the preferred embodiments of the present invention, the invention is susceptible to modification, variation and change without departing from the proper scope and fair meaning of the accompanying claims.

What is claimed is:

1. A power actuator for a hinged vehicle door with a generally vertical hinge axis, the power actuator comprising:
a motor-gearbox assembly,
a slip clutch,
a friction brake,
a threaded spindle with a motor-side bearing, and
a spindle nut affixed to a spindle tube, configured to travel along the threaded spindle during a rotation of the spindle,
wherein the slip clutch and the friction brake are operatively positioned between the motor-gearbox assembly and the motor-side bearing.

2. The power actuator according to claim 1, wherein the power actuator does not include a biasing element acting on the spindle nut toward an extended position.

3. The power actuator according to claim 1, wherein the slip clutch is operatively disposed between the motor-gearbox assembly and the friction brake.

4. The power actuator according to claim 1, further comprising a circuit board arranged on a side of the a motor-gearbox assembly remote from the threaded spindle.

5. The power actuator according to claim 1, further comprising a housing having a motor tube and a spindle tube, wherein the motor tube is composed of two half shells surrounding the motor-gearbox assembly, the slip clutch, the friction brake, and the motor-side bearing.

6. The power actuator according to claim 5, wherein the motor tube is located proximate to a door-side end of the power actuator and the spindle tube is located proximate to a frame-side end of the power actuator.

7. The power actuator according to claim 5, further comprising a door-side socket fixedly connected to the motor tube and a frame-side socket fixedly connected to the nut tube, wherein the door-side socket is configured to form a part of a door-side ball-and-socket joint, and the frame-side socket is configured to form a part of a frame-side ball-and-socket joint.

8. A motor vehicle comprising:
a vehicle body with a door frame,
a vehicle door opening and closing about a generally vertical hinge axis, and
a power actuator according to claim 1,
wherein the door frame includes a frame bracket located laterally inward from the vertical hinge axis with respect to the vehicle body, the frame bracket having a frame ball that forms a part of a frame-side ball-and-socket joint and cooperates with a frame-side socket fixedly connected to the nut tube of the power actuator.

9. The motor vehicle according to claim 8, wherein the vehicle door includes a door bracket fastened to a structural bottom part of the vehicle door, the door bracket having a door ball that forms a part of a door-side ball-and-socket joint and cooperates with a door-side socket fixedly connected to the motor tube of the power actuator.

10. The motor vehicle according to claim 8, wherein the power actuator extends in a generally horizontal direction.

11. The motor vehicle according to claim 8, wherein the motor-gearbox assembly of the power actuator is disposed inside the vehicle door and the spindle tube extends out of the door to the frame-side ball-and-socket joint.
